(19) United States
(12) Patent Application Publication
(10) Pub. No.: US 2007/0033649 A1
(43) Pub. Date: Feb. 8, 2007

(54) Secure remote access technology

(75) Inventor: Inge Eivind Henriksen, Oslo (NO)

Correspondence Address: SIERRA PATENT GROUP, LTD., 1657 Hwy 395, Suite 202, Minden, NV, 89423, US

(73) Assignee: BooleanSoft

(21) Appl. No.: 11/186,491

(22) Filed: Jul. 20, 2005

(51) Int. Cl. H04L 9/32

(52) U.S. Cl. 726/20

(57) ABSTRACT

A computer program product, a software program product kit, and a data/telecommunications network where the software is installed, providing secure remote access. The installed software or computer program product incorporates a password generating module which generates a user associated password based on a first set of data related to a user, a second set of data related to a hardware token, a third set of data related to a password server, and a fourth set of data related to current time.

### BACKGROUND OF THE INVENTION

1. Field of the Invention

The present invention generally relates to computer systems having remote access technology for allowing a user to gain access remotely to the resources of a computer system, e.g. an enterprise mainframe, Internet/Extranet/Intranet infrastructure based solutions, in a secure manner. The technology of the present invention is useful in protecting a user's sensitive information in electronic commerce and electronic business by providing a secure access solution for users of such systems, and a means for digitally signing electronic transactions.

1. Description of Related Art

At present there is a high demand for anytime, anywhere access to services provided via telecommunications and/or data networks. Even though technical solutions to this problem are already available, there are certain risks associated with the possibility of unintended exposure of sensitive data stored in enterprise mainframe Internet/Extranet/Intranet infrastructures to a non-intended audience. Thus, there is still some reluctance to providing and using such remote access solutions.

Some solutions are today available which help to improve the security of such systems. One known example, which this inventor/applicant considers the closest art related to this invention, is marketed by RSA Security Inc., as US-based company, on their web-pages at www.rsasecurity.com. The solution mentioned is claimed to provide a company or organization with a convenient way of creating trusted identities for employees, customers, partners, suppliers and consultants. In the RSA SecurID® solution, based on strong authentication technology, distinctive user tokens are provided which display a time-sensitive access code. Formats include key fob (a type of security token: a small hardware device with built-in authentication mechanisms) and PIN Pad hardware tokens and software tokens for desktops, notebooks, PDAs and mobile phones. This solution is intended for use with many access methods available today, such as SSL VPN, IP Sec VPN, portals, terminal services, Microsoft Outlook web access technology, wireless LANs and the business applications of leading vendors of business software.

Another solution on the market is provided by Vasco Data Security NV/SA of Wemmel Belgium. At the web site www.vasco.com, there is presented an access solution called Digipass® Desk 300 based on strong two-factor authentication. In this solution access to applications and services requires a user to use a Personal Identification Number (PIN) and a Digipass® Desk 300 hardware device. Upon entering a user PIN code into the hardware device, a dynamic password is calculated. This is a one-time password which enables authorized access into the network. There is, however, a certain production cost related to the hardware device which comprises hardware circuits and a user keypad.

On the one hand, very simple solutions using static passwords tend not to be considered adequately secure in regard to many services which today may be offered via the Internet. On the other hand, the solutions available today which tend to be regarded as adequately secure, e.g. for an Internet Bank service, require supplying each user with a costly hardware device.

Hence it is a primary object of this invention to provide a password based secure access solution and related products which are less costly than present solutions, while at the same time offering a level of security comparable to present solutions considered to have a high level of security.

It is an object of this invention to provide a password based secure access technology which is simple to produce and distribute to the customers and their clients, and which maintains a high level of security.

### SUMMARY OF THE INVENTION

Embodiments of the present invention generally provide a computer software program product for generating a user access password in a data system or telecommunications network. The program product comprises a password generating module which generates a user associated password based on a first set of data related to a user, a second set of data related to a hardware token, a third set of data related to a password server, and a fourth set of data related to current time. This solution enables secure e-commerce and e-business in a cost effective manner, as systems using this program product can be realized without distribution of devices having costly hardware, be it keypad based devices or other electronic hardware. In one alternative embodiment of the invention, the user related information comprises a personal code, such as e.g. a PIN code. In another alternative embodiment of the invention, said user related information comprises a token identification number with and provided by said user. These codes can be communicated to the user in a simple and effective manner, e.g. in a letter.

In yet another embodiment of the computer program product according to the invention, said user related information comprises a license identification number provided with software which is associated with or an integral part of a token delivered to said user.

In a further embodiment, the computer program product according to the invention comprises a data encryption module adapted to use standardized data encryption techniques and mathematical algorithms to generate a password based on said user related information.

In yet another embodiment of the computer program product according to the invention, the password generation module is adapted to incorporate in the calculation of password time information retrieved from a Daytime server.

In another aspect of the invention, there is provided a data storage medium having stored thereon a computer program product as discussed above. In one alternative embodiment of the data storage medium according to the invention, the storage medium includes a token identification number storage region from which a user may access a token identification number. In a preferred embodiment of the data storage medium according to the invention, the medium is designed in a form similar to a CD (Compact Disc) which is insertable into a data storage medium receiving unit of a computer, e.g. a CD (Compact Disc) station of a PC.

In yet another aspect of the invention, there is provided a data network with user access functionality which includes a user terminal unit having an interface module for allowing input of information by a user, e.g. a user related pin code, into said network. The network also includes a computing module suitable for running a computer program as described above. Further, the computing module of the network is adapted to generate a password for use by said user in accessing at least parts of said network.

In a preferred embodiment of a network according to the invention, the network comprises a storage medium receiving station, e.g. a CD-ROM station of a PC, for receiving a data storage medium as described above and for entering of a computer program product as described above into a computing unit on said network.

In a further aspect of the invention, there is provided a computer program product comprising code for generating a password for use by a user in accessing an access-limited service in a data/telecommunications network. The program comprises an encryption module for generating an encrypted password. The program also comprises a user interface module for providing the encryption module with at least two elements of information, the first of which is related to said user, the second of which is related to a hardware token. Further the program comprises a server information module for providing the encryption module with data related to the service to be accessed by the user, and a time module for accessing an external Daytime server to retrieve time data, in order to supply the encryption module with time data related to current time. This way the encryption module can generate a time dependent password for a user.

In yet another aspect of the invention, there is provided a password generating computer program product for generating a password to be presented for a user using a user terminal. The password program comprises an encryption module adapted to encrypt a combination of a first data set related to said user, a second data set related to a hardware token made available to said user, a third set of data related to a password server, and a fourth set of data retrieved from a Daytime server and indicating the current time. These data are combined into a one-time password which can be used by said user to obtain access to a service made available in a data/telecommunications network, said network including said password server and said time server.

In an additional aspect, the invention provides a software product kit of parts for installing and running a software/hardware based password service in a network which offers any number of other network based services to one or more users presenting a valid password. The kit comprises a password server program product installable in said network where the server is adapted for creating and updating access passwords related to all of said one or more users. Further, the kit comprises at least one user password generating program product which is installable in a user terminal for accepting input data from a user and generating and supplying a user with a valid password with which said user may access said data/telecommunications network. The password server program product and the user password generating program product of the kit according to this aspect of the invention are adapted to separately connect via said network to a Daytime server for retrieving current time data, and to use said current data as an input to a password generating algorithm.

In a further aspect of the invention, there is provided a data/telecommunications network for providing a service to one or more authorized users which comprises a service providing module designed to be made accessible to a set of authorized users by password input. In the data/telecommunications network a data storage module stores data related to each authorized user. The stored user data includes valid password(s). The data/telecommunications network according to this aspect of the invention also includes a password server with code for creating and updating the password(s) in the data storage module, and at least one user module with a user interface adapted for input and output of user data. The user module includes user password generating program code. The password server and the user password generating program code are adapted to establish a connection with and communicate with a Daytime server for retrieving current time data and the password server and the user password generating program code are also adapted to use said time data as input data. Thereby time dependent passwords are provided to a user such that when a service receives as input from a user the password generated, said service will give the user access to said service.

### BRIEF DESCRIPTION OF THE DRAWINGS

In order to make it easier to understand the above recited features and additional technical details and functionality of the invention, a more particular description of the invention, briefly summarized above, may be had by reference to the embodiments described below, some of which are illustrated in the appended drawings. It should be noted that the appended drawings illustrate only typical embodiments of this invention and are therefore not considered limiting in scope in so far as the scope of the claimed invention may admit to other embodiments which can be equally effective.

FIG. 1 is a schematic illustration of a typical embodiment of a network according to the invention, exemplified with an Internet Bank server with secure access for users.

FIG. 2 illustrates the software components of a remote access system according to the invention and its connection with e.g. an enterprise mainframe software.

FIG. 3 illustrates generally one example embodiment of a token CD card according to this invention in which the token software to be run or installed in a user terminal is stored, such as e.g. in a PC with a CD-station, operated by a typical user.

FIG. 4 illustrates schematically, using a flowchart, the steps performed according to the invention by the token software for generating a password.

FIG. 5 illustrates schematically, using a flowchart, the steps performed in one example embodiment of a Dynamic Password Server according to the invention for updating a password corresponding to one or several tokens and stored in a data storage unit.

FIG. 6 illustrates one example embodiment of the steps performed in preparing a secure remote access password based kit or package according to the invention.

FIG. 7 illustrates the typical steps involved in one example embodiment of a user session operating the token CD card.

FIG. 8 illustrates in general an embodiment of the network according to the invention where the user terminal is a mobile phone device and a telecommunications network is included in the network.

### DETAILED DESCRIPTION OF THE PREFERRED EMBODIMENTS

Persons of ordinary skill in the art will realize that the following disclosure is illustrative only and not in any way limiting. Other embodiments of the invention will readily suggest themselves to such skilled persons having the benefit of this disclosure.

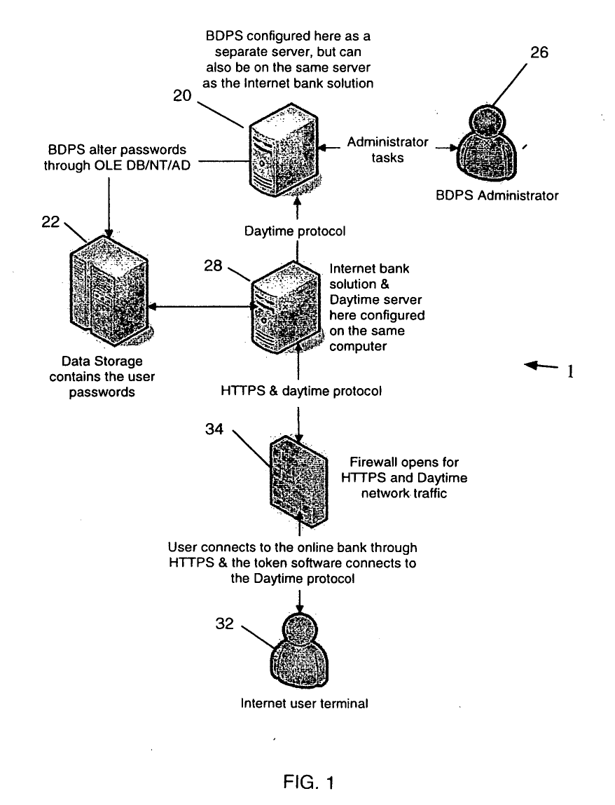

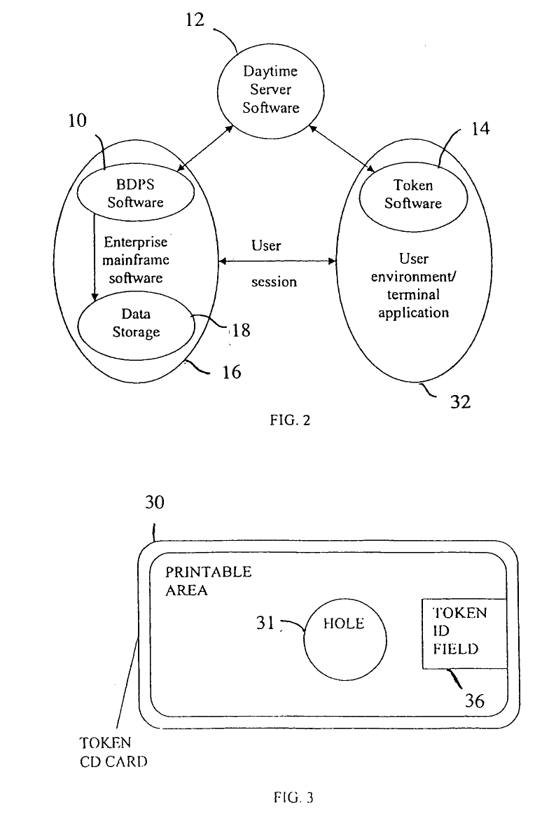

In FIG. 1, an example digital network 1 for running an Internet Bank with secure access according to the invention is illustrated, and FIG. 2 illustrates corresponding software components of a remote access system according to the invention and its connection with e.g. enterprise mainframe software. The system according to this invention will in this description be referred to as BRAT (BooleanSoft Remote Access Technology).

Central to the solution according to this invention are three individual software applications, a Dynamic Password Server 10, a Daytime Server 12, and any number of client applications, denoted Tokens 14. FIG. 2 illustrates how these three software applications may communicate between themselves via any type of suitable software/hardware connection, and with an enterprise mainframe or Internet/Extranet/Intranet infrastructure software environment 16 and a user environment/user terminal application 32.

FIG. 1 illustrates how one Dynamic Password Server (BDPS) computer 20 is set up to be connected to a Data Storage 22 related to an enterprise mainframe or an Internet/Extranet/Intranet infrastructure solution via a common data access protocol 24 like OLE DB. In this way, the BDPS computer 20 can update the passwords in the Data Storage 22 of the enterprise mainframes, Internet/Extranet/Intranet infrastructure solution. The system could be set up to perform this update at set time intervals. As an example, an administrator 26 could set up the BDPS computer 20 to change the password of all users as often as once every minute. In this way, the passwords will be considered as dynamic, constantly changing dynamic passwords, and the passwords may be referred to as one-time passwords.

Additionally, the BDPS computer 20 can, via OLE DB 24, change Windows NT(®) local user, workgroup users and domain user passwords, Microsoft(®) Active Directory user passwords, and UNIX style password files.

In FIG. 1, the BDPS computer 20 and Data Storage 22 of the enterprise mainframes or Internet/Extranet/Intranet infrastructure solution is shown to be on two different physical machines. These two machines could be arranged at completely different locations. However, the BDPS software 10 and Data Storage handling software 18 of the enterprise mainframes or Internet/Extranet/Intranet infrastructure solution could be on the same server. There is only a requirement that there is a valid electronic connection, e.g. using OLE DB, between the BDPS computer 20 and the data storage 22 in question at the time of password update.

The Daytime Server application 12 is a software application generally supplied for free with most server operating systems (e.g. Windows 2003/2003, Windows NT® and Linux/UNIX), and provides the current date and time set on the server (Example: “Mon Jun. 13, 2005 02:53:25”).

The Daytime Server 12 is an important part of BRAT. Firstly, the BDPS 10 uses the Daytime Server 12 to find out when it is time to update the passwords. Next, the Daytime Server 12 is used by the Tokens 14 to recalculate the password to the user. Finally, data from the Daytime Server 12 is an input into the digital signature (password) algorithm.

The Daytime Server 12 and the BDPS 10 may be on the same server, or on two servers at two different geographic locations, the only requirement being that there is a valid electronic data connection between BDPS 10, the Token(s) 14 and the Daytime Server 12 in question.

The Token or client application software 14 is generally supplied, one to each user, on a portable data storage medium, e.g. a Token CD Card 30, illustrated on FIG. 3. Each Token CD Card also has stored on it (or in it) a unique token ID, for example a token identification number (e.g. 123456789) recorded or printed on a part or region on or near the surface of the Token CD Card 30. The reason that each Token Card 30 has a unique id is that no two tokens should give the same password as a result.

The Token ID is never transmitted over the enterprise mainframe or Internet/Extranet/Intranet infrastructure solutions network, and it can therefore not be accessed by other means than by physically getting hold of the Token CD Card 30.

In FIG. 1, an Internet Bank solution is shown together with a Daytime Server on the same computer, the customer computer 28. The BDPS 20 is connected to the customer computer 28 using a Daytime Protocol. The Daytime Protocol is designed for the supply of Daytime Data from the Daytime Server to other parts in a network, e.g. the customer computer 28 or a user terminal 32. In addition, the Customer Computer 28 is connected to the User Password Storage 22.

An Internet user will typically connect from a User Terminal 32 to an Internet Bank through using HTTPS 34. The Token Software of the User Terminal 32 connects to the Daytime Server via a Daytime protocol in order to retrieve Daytime Data to be used to generate the user password in the user terminal.

When a customer purchases a BRAT solution, a minimum number (e.g. 1000) Token CD Cards 30 will be provided by a BRAT supplier to a purchasing party, possibly packaged together with the BPDS software 10 stored on a CD or DVD. The Token CD Cards 30 can be distributed to a number of individual customers or client using services provided by the BRAT purchasing party, e.g. a bank providing Internet-based banking services to its customers.

A Token CD Card is preferably designed with the size of a standard credit card, i.e. a flat object of 85 mm×58 mm. The Token CD Card 30 may hold 30 MB of data. The Card 30 is also designed so at to define a physical hole 31 in its center area in order to fit into most CD players, except slide-in CD-players. The Token CD Card is preferably so small, in order to make it convenient to carry while traveling. It fits into a wallet together with other cards, e.g. credit cards. It is a very useful feature that the token is convenient to carry; as people will want to securely access their enterprise mainframe or Internet/Extranet/Intranet infrastructure solutions from different computers at different geographical locations.

Prior to delivery, the Token CD Cards are supplied with a set of data, some of which must be provided by the purchaser of the BRAT solution:

Daytime server name (e.g. “time.mybank.com”)

Daytime server port/socket (e.g. 13)

Daytime server protocol (e.g. UDP or TCP)

Webpage of the customer that has purchased the solution (e.g. http://www.mybank.com), or it can be directed towards the solution login (e.g. https://secure.mybank.com login/)

What language to use

All print graphics such as the print graphics on the token CD front side, and also print for other optional accompanying leaflets, such as a sleeve for the CD token card etc.

How frequently, in minutes, that the passwords should be updated

Multimedia (optional).

Data for the token can be uploaded to the BooleanSoft website where they will be handled by an appropriate customer representative.

In addition to the above data, the following setup information is supplied by the provider of the BRAT solution:

A unique license ID

A unique Token ID (different for each Token CD Card)

Some of this information may be recorded on the Token CD Card:

Daytime server name

Daytime server port/socket

Daytime server protocol

Webpage of the customer that has purchased the solution

The unique license id

How frequently, in minutes, that the passwords should be updated

Multimedia

A unique Token ID may for example be printed on the surface of the Token CD and covered by scratch field ink. To reveal the unique token ID the user then has to scratch the field 36 until the unique Token ID is revealed. The scratch field 36 ensures the user that he/she is the first person which uses the Token CD Card 30, and that no one knows his/her unique token CD Card ID. If the scratch field is gone, then the user should alert the company deploying the token CD Cards about a violation of his/her private information. The CD card should always be kept private, and lost cards should be reported to the purchaser or a BRAT solution in order to prevent misuse.

The user is only required to type in the Token ID if the Token software is being run from the CD, and is not installed on the user terminal. If, however, the user terminal is considered a safe and trusted terminal, the token software may be installed on such a user terminal, e.g. a computer device, such as a PC or mobile device. Then only one element of information related to the said user needs to be input by the user.

The Unique license ID is a GUID (Globally Unique Identifier) which is unique for each BDPS server license and is hidden from users view. The user of a Token will never be shown, or will never be asked to enter the unique license id. The unique license ID is never transmitted over the enterprise mainframes, Internet/Extranet/Intranet infrastructure network solutions.

The unique license ID is included in the digital key algorithm to protect against Keyboard Sniffers on public computers. A keyboard sniffer is a piece of software which hackers may try to use to register everything that is typed on a PC's keyboard, and can be found installed on public computers, such as in an Internet Cafe. In the unlikely scenario that a user has had his/her personal pin code and unique token stolen by a hacker, then the generated password will be wrong without a Token CD that contains the unique license ID.

The unique license ID is never transmitted over the enterprise mainframes, or Internet/Extranet/Intranet infrastructure solutions network. The unique license ID is obfuscated inside the token software 14, in the BDPS 10 it may, for example, be stored in the Microsoft® Data Protection API (DPAPI) 10.

The personal PIN code is similar to any other PIN code used in everyday life, typically a four-digit number. The personal PIN code should be kept personal, and not written down or given to anyone else.

The pin code is entered by entering the pin code on an input device, such as a keyboard. In an alterative embodiment of pin code input, one is only permitting the users to enter the pin code by clicking the mouse on a numeric keys displayed in the graphical user interface of the token software, this has the added benefit of protecting against Keyboard Sniffer software from stealing the user's pin codes.

The personal PIN-code is never electronically transmitted over the enterprise mainframes, Internet/Extranet/Intranet infrastructure network solutions. PIN codes can be changed by the BDPS administrator at his/her discretion.

Upon request of the customer, the Token CD card 30 can also be provided with additional multimedia data for the customer. The optional multimedia data can be made to start automatically when the user inserts the token CD card 30 in a CD station, and/or it can be started from the graphical menu that is displayed after the user inserts the token CD card. Here are some examples of proposed optional multimedia data:

Instruction video on how to use the customer's solution

Manual on how to use the customer's solution

Commercial videos, images or sounds

Video and/or sound presentation of the customer's company

Having now described some of the features of the software and hardware associated with the invention, it will now be described how a digital signature is generated by the Token software application and how a Token CD Card is used in practice.

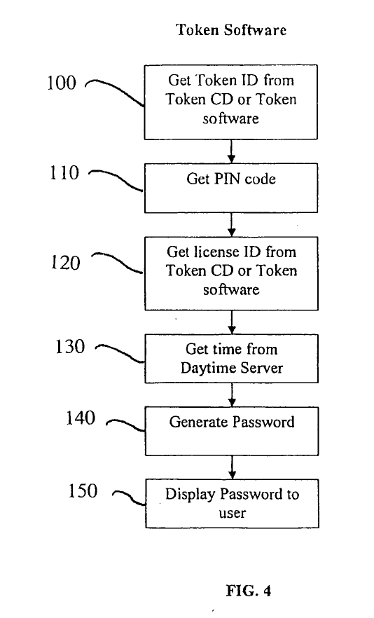

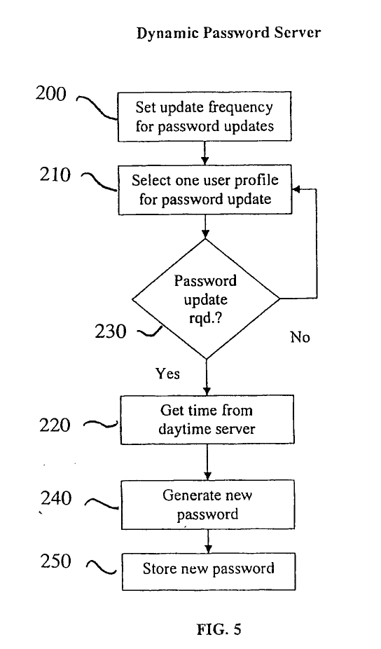

FIG. 4 illustrates the main steps performed by the Token software in order to generate a password. In this example, the program first retrieves 100 a token ID number being input by a user on at a suitable user interface, such as e.g. a conventional computer keyboard device. Then the program retrieves 110 a PIN code also being input by a user, preferably from the same user interface. Then the token software retrieves 120 the hidden unique license ID stored within the token software itself. Finally, the Token Software retrieves 130 Daytime server data.

Having gathered these four pieces of information, the Token Software can generate 140 a one-time password which at this moment in time will be sufficient for a user to gain access to the service related to this user and the related Token CD Card. The password is generated using advanced standardized data and encryption and advanced standardized mathematical algorithms. As an example the AES, The Advanced Encryption Standard, (FIPS 197, retrievable at http://csrc.nist.gov/publications/fips/fips197/fips-197.pdf) could be used as an encryption algorithm. When the password has been generated, it will be displayed 150 on a display device, in order that a user may memorize this password and use it as part of a subsequent log in procedure for a service available, for example, from an enterprise mainframe via a computer network, i.e. it could be made available on a home PC via standard Internet technology, the details of which will be apparent to a person skilled in the art.

The PIN code and the Token are useless on their own, but together with the Daytime Server Data, they can be used by the Token software to generate a valid password. If a user mistypes either the PIN code or a Token ID, a wrong password will result. Some typical scenarios would be:

A user looses a Token. Without the corresponding PIN code, the Token is of no use to anyone else than the authorized user.

A PIN code is unintentionally disclosed to an unauthorized third party. Without the token such a third part can make no use of the PIN code.

Even though both the PIN code and the Token ID number is obtained by a third party, these cannot be used to access your service without your physical token Card and the Unique license stored on this Card.

Thereby a two-factor security solution is created, where at least three unique codes are required to generate a password or digital signature.

A Dynamic Password Server could be running as a part of the enterprise mainframe or Internet/Extranet/Intranet infrastructure environment, but could also be running in a separate environment connected to the enterprise mainframe or Internet/Extranet/Intranet infrastructure environment, and will ensure that a local data storage unit maintains updated records of current passwords for all users, in order that a password used in a users log-in session may be compared with a stored password for the same user.

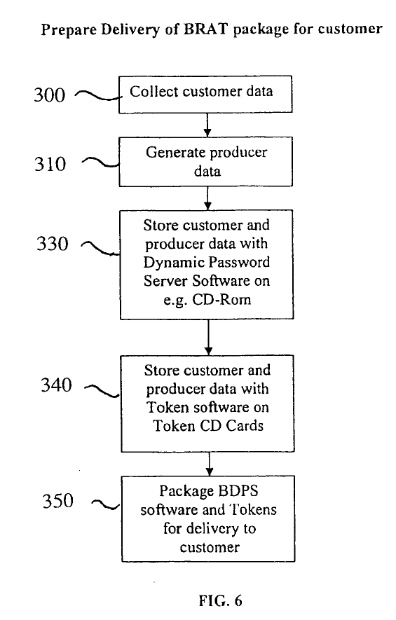

FIG. 5 illustrates the main steps in a software process for updating the stored passwords. An update frequency is typically set 200 prior to delivery. Then the program will select 210 a user having his/her profile stored in the Password Server. Associated with each password the Dynamic Password server will maintain a time indicator, such as e.g. a time record retrieved from the Daytime Server when the Password was set, in order at some later time to retrieve current Daytime Data and to check 230 if the password is so old that an update of the password is required. If so, data is retrieved from the Daytime server 220 and a new password will be generated 240. The new password is stored 250 in the Data Storage.

FIG. 6 illustrates the main steps in preparing for delivery of a BRAT solution to a customer. Customer data are collected 300. Then the producer data that is required to follow with the product is collected or generated 310. The collected customer and producer data are stored 330 with the Dynamic Password Server software on a digital software storage medium, e.g. a CD-ROM or DVD. The collected customer and producer data are also stored 340 together with the Token CD Software on each of the Token CD Cards, packaged 350 and shipped with the Dynamic Password Server CD-Rom to a customer.

The following scenario example suggests the action taken by a BDPS administrator when shipping a token CD card to a user (John Smith):

1. The BDPS administrator gets the unique user name or user id from the customer solution (BRAT solution), in this example the unique user id is his login name; John_Smith

2. The BDPS administrator adds a new user in BDPS called John_Smith

3. The BDPS administrator picks up a new token CD card

4. The BDPS administrator reads the unique license id that is written on the note that follows each token CD card, and enters it into BDPS as part of John_Smith's user information. There is no need to enter user's personal pin code as this is automatically generated

5. The BDPS administrator submits the information about John_Smith to BDPS

6. The BDPS administrator prints the standard document to be sent to the user, this normally contains the pin code, the user name or user id. This standard document is fully editable by the BDPS administrator before printing.

7. A customer employee disposes of the note with the unique token id, preferably the note should be shredded before thrown in the trash bin

8. Shipping to the customer may be done in various ways, some more secure than others:
Send a package containing both the token CD card and the letter with the personal pin code (least secure method)
Send first one package containing the token CD card, then one separate letter containing the letter with the personal pin code (medium secure method)
Send first one package containing the token CD card, and then use a different medium to send the letter with the personal pin code (more secure). This alternative medium might be:
   a. SMS text message to the users mobile phone
   b. Secure E-mail
   c. The user must login to a web site to get the pin code
   d. Use of a second delivery firm; first package might be delivered by ordinary mail and the letter with the personal pin code can be delivered to the user's home or business address by DHL, UPS or some other trusted delivery company.
Use a package delivery firm that delivers the token CD card and the letter with the personal pin code to the home or business address of the user, the user must legally identify him/her to the delivery agent to get the package(high security)
The user must come and pick up the token CD card and personal pin code at the customer office, where he/she must legally identify him/her(most secure)

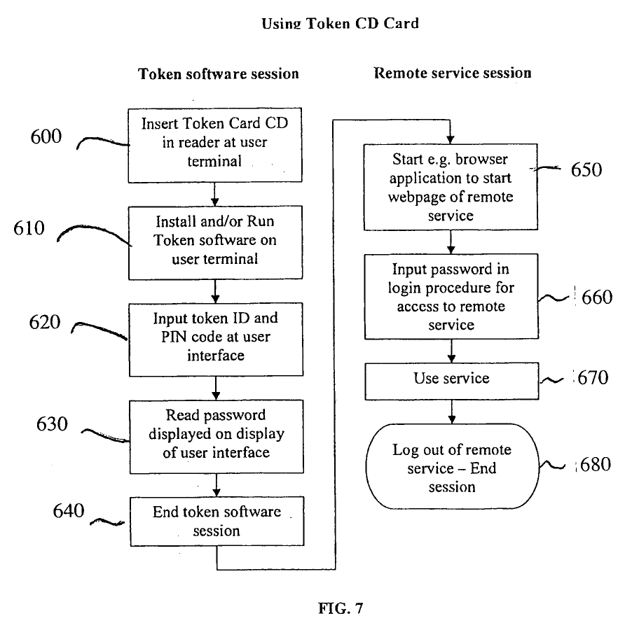

To a user, using a token CD card is easy, refer also to FIG. 7; the CD is inserted into the CD drive of a PC running a Windows(®) operating system at step 600. After booting the user will get a graphical menu with the following options:

Start the token software

Install the token software

Visit the enterprise mainframes, Internet/Extranet/Intranet infrastructure solutions webpage

Optional multimedia

Upon receipt of a Token CD Card, a User will typically perform the following actions:

1. When the user has received both his/hers token CD card and the letter containing his/hers personal pin code, then the user should first ensure that the scratch field on the token CD card is unscratched. If the scratch field has been tampered with the user should notify a customer representative that will prompt the BDPS administrator to send a new token CD card to the user, and to block the unique token id that was used on the previous token CD card. If the scratch field is untouched, then the user knows that he/she is the only one that knows their token CD cards unique token id.

2. The user inserts the token CD card in his/hers CD ROM.

3. At step 610, the user chooses from the menu if to:
a. Start the token software
b. Install the token software

4. At step 620, the user logs into the customer solution for the first time using:
a. The user name or user id written on the standard letter (e.g. John_Smith)
b. Personal pin code written on the standard letter
c. The unique token card id (only if the user is starting the token software without having installed it first)
   Starting the Token Software:

Starting the token software immediately, no installation is necessary. The user will be prompted to type in the unique token id, and the personal pin code 620. After the user has entered these two codes, the password will be shown on screen together with a dialog 630 on how long it is until the password expires.

When the password expires it will automatically update. After five minutes the software will automatically prompt for the unique token id and the personal pin code again, this is as an added precaution in case the user forgot to close down the token software.

If the user types a wrong unique token id or a wrong personal pin code, there will be no error message, but the generated password will be wrong. This is to avoid hackers using automated password guessing programs; since the token software cannot distinguish between a valid input and an invalid; it causes automated password hacking tools to be rendered useless.

Starting the token software immediately is useful if using a public PC, like a computer in an Internet café. Since no installation is required, the user doesn't need any special administrator access to the computer in question, and the user doesn't have to leave a copy of the token software on the computer.

Since the unique token id written on the token CD card is long and difficult to remember, the users will have to eject the CD drive to read the unique token id. This has the added benefit of making it less likely that the user forgets the token CD card inside the CD drive by mistake. Note that the token CD card does not have to be inserted in the CD drive again to continue using the token software after it has started.

If the token CD card is still in the drive when the user closes the token software, an alert saying “The token CD card is still in the CD ROM drive” is displayed, and the CD ROM is automatically ejected. This is to avoid users forgetting the token CD cards in the CD ROM drive on public computers, like in Internet cafés.

Install the Token Software

If the user is using his/hers home computer, or another computer that is trusted, then the user can choose to install the token software on that computer. Installing the token software means that the user can start the token software without the token CD card. The user does not need to enter the unique token id, but only the pin code is required.

Visit the Enterprise Mainframes, Internet/Extranet/Intranet Infrastructure Solutions Webpage

When a user has been provided with a password, the Token Software session may end 640. The user may then select to visit 650 the enterprise mainframes, Internet/Extranet/Intranet infrastructure solutions webpage. A graphical menu will open an Internet Browser and go to the enterprise mainframes, Internet/Extranet/Intranet infrastructure solutions webpage of the customer that has purchased the solution.

At this point the user will be prompted for the input of a password as part of a login procedure 660 for access to the service. When the user then provides, e.g. by typing on a keyboard of the user terminal, the valid password that he/she had previously been provided with, he/she will be given access to the service, unless the password has already expired. Having performed the desired actions 670 with the service provider, the user will log out 680 of the remote system.

In the above description, an embodiment of the invention is detailed wherein the network comprises a data network and a number of computers connected to the network. Typically, the Internet service terminal (user terminal) 32 would be a PC (Personal computer) or similar device.

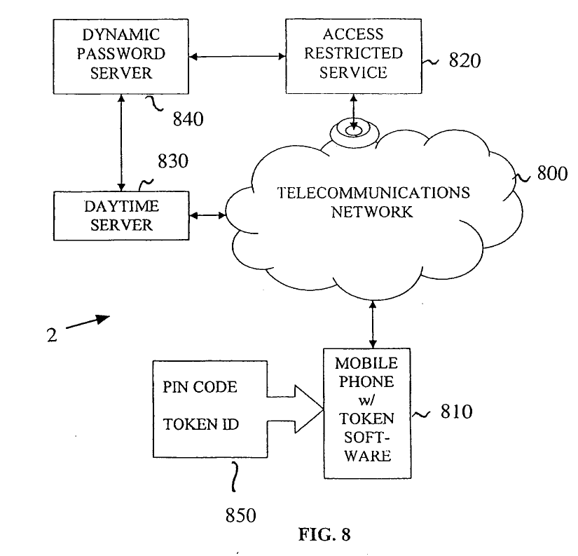

In another embodiment of a network according to the invention illustrated in FIG. 8, the network 2 comprises a telecommunications network 800. The user terminal is a phone device, e.g. a mobile phone 810. A mobile phone would in this case be provided with a Token Software module which is adapted to provide a user with passwords presented on the display of the mobile phone device after a user has input 850, using e.g. the keypad of the mobile phone, a PIN-code and a Token ID number. In this way the user may use the generated password to access a service 820 available via the telecommunications network. A Daytime Server 830 may be an integral part of the telecommunications network 800 or it could be a separate unit communicating with the network 800. The Token Software of the mobile phone 810 would be adapted to retrieve Daytime Data from the Daytime Server 830 via the Telecommunications Network 800 in order to generate a password based on current time. Further, a Dynamic Password Server 840 could be arranged separated from but connected to the Service providing unit 820, but it could also be an integral part of the Service providing unit 820. The task of the Dynamic Password Server 840 is, as in the previously explained embodiment of the invention, to generate, maintain, and store currently valid passwords for all users, in order that the access restricted service providing unit 820 may verify if a user is authorized to be given access to said service 820 via a login procedure.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiment disclosed as the best mode contemplated for carrying out this invention.

What is claimed is:

1. A computer software program product for generating a user access password in a data system or telecommunications network, said program product comprising:
a password generating module which generates a user associated password based on a first set of data related to a user;
a second set of data related to a hardware token;
a third set of data related to a password server; and
a fourth set of data related to current time.

2. The computer program product according to claim 1, wherein said first set of data related to said user comprises a personal code provided by said user.

3. The computer program product according to claim 2, wherein said personal code is a pin code.

4. The computer program product according to claim 1, wherein said first set of data related to said user comprises a token identification number related to a token associated with and provided by said user.

5. The computer program product according to claim 1, wherein said first set of data related to said user comprises a license identification number provided with software which is associated with or an integral part of a token delivered to said user.

6. The computer program product according to claim 1, further comprising a data encryption module adapted to use standardized data encryption techniques and mathematical algorithms to generate a password based on said first set of data related to said user.

7. The computer program product according to claim 1, wherein said password generating module is adapted to incorporate time information retrieved from a Daytime server in the calculation of a password.

8. A data storage medium having stored thereon a computer program product for generating a user access password in a data system or telecommunications network, said program product comprising:
a password generating module which generates a user associated password based on a first set of data related to a user;
a second set of data related to a hardware token;
a third set of data related to a password server; and
a fourth set of data related to current time.

9. The data storage medium according to claim 8, comprising a token identification number storage region from which a user may access a token identification number.

10. The data storage medium according to claim 8 designed in a form similar to a CD (Compact Disc) and insertable into a data storage medium receiving unit of a computer.

11. A data network with user access functionality, said network comprising:
a user terminal unit having an interface module for allowing input of information by a user into said network;
a computing module programmed to run a computer program for generating a user access password, said program comprising a password generating module which generates a user associated password based on a first set of data related to a user, a second set of data related to a hardware token, a third set of data related to a password server, and a fourth set of data related to current time,
wherein said computing module is adapted to generate a password for use by said user in accessing at least parts of said network.

12. The network according to claim 11, comprising a storage medium receiving station for receiving a data storage medium having stored thereon a computer program product for generating a user access password in a data system or telecommunications network, said program product comprising a password generating module which generates a user associated password based on a first set of data related to a user, a second set of data related to a hardware token, a third set of data related to a password server, and a fourth set of data related to current time and for entering said program product into a computing unit on said network.

13. A computer program product comprising code for generating a password for use by user in accessing an access-limited service in a data/telecommunications network, said program comprising:
an encryption module for generating an encrypted password;
a user interface module for providing the encryption module with a least two elements of information, the first of which is related to said user, the second of which is related to a hardware token;
a server information module for providing the encryption module with data related to said service to be accessed by said user; and
a time module for accessing an external Daytime server to retrieve Daytime data, in order to supply the encryption module with time data related to current time,
wherein the encryption module can generate a time dependent password for a user.

14. A password generating computer program product for generating a password to be presented for a user using a user terminal, said program comprising an encryption module adapted to encrypt a combination of a first data set related to said user, a second data set related to a hardware token made available to said user, a third set of data related to a password server, and a fourth set of data retrieved from a time server and indicating the current time, into a one-time password which can be used by said user to obtain access to a service made available in a data/telecommunications network, said network including said password server and said time server.

15. A software product kit of parts for installing and running a software/hardware based password service in a network offering any number of other network based services to one or more users presenting a valid password, said kit comprising:
a password server program product installable in said network, said server being adapted for creating and updating access passwords related to all of said one or more users; and
at least one user password generating program product installable in a user terminal for accepting input data from a user and generating and supplying a user with a valid password with which said user may access said data/telecommunications network,
wherein the password server program product and the user password generating program product are adapted to separately connect via said network to a Daytime server for retrieval of current Daytime data, and to use said current data as an input to a password generating algorithm.

16. A data/telecommunications network for providing a service to one or more authorized users comprising:
a service providing module designed to be made accessible to a set of authorized users by password input;
a data storage module having stored data related to each authorized user, said user data including passwords;
a password server with code for creating and updating said passwords in said data storage module; and
at least one user module with a user interface adapted for input and output of user data,
wherein said user module includes user password generating program code, said password server and said user password generating program code are adapted to establish a connection with and communicate with a Daytime server for retrieving current Daytime data, and said password server and said user password generating program code are adapted to use said Daytime data as input data, thereby providing time dependent passwords to a user, such that when said service receives said generated password as an input from a user, said service will provide said user with access to said service.

17. The data storage medium according to claim 10, wherein said data storage medium receiving unit of a computer is a CD (Compact Disc) station of a PC.

18. The data network of claim 11, wherein said information by a user is a user related pin code.

19. The network according to claim 12, wherein said storage medium receiving station is a CD-ROM station of a PC.
